(19) United States
(12) Patent Application Publication
(10) Pub. No.: US 2014/0100895 A1
(43) Pub. Date: Apr. 10, 2014

(54) HOTEL BOOKING MANAGEMENT SYSTEM

(71) Applicant: PENG-YU CHEN, NEW TAIPEI CITY (TW)

(72) Inventor: PENG-YU CHEN, NEW TAIPEI CITY (TW)

(21) Appl. No.: 13/647,582

(22) Filed: Oct. 9, 2012

(51) Int. Cl. G06Q 10/02

(52) U.S. Cl. 705/5

(57) ABSTRACT

A hotel booking management system has a member services platform, a hotel information services platform, a guest operation interface and a hotel management interface. The guest operation interface serves for a guest to connect a mobile device thereof to the member services platform in completion of a membership registration. When the registration is completed, a membership registration module of the member services platform transmits a dedicated two-dimensional barcode to the mobile device. When the guest is checking in, the guest only has to provide the 2D barcode for scanning such that the hotel management interface can read corresponding registration information of the guest to rapidly finish the check-in procedure. Using the foregoing technique allows guests to perform fast on-line booking of hotel accommodation, and hotels can transmit information dedicated to guests through the hotel information services platform.

### BACKGROUND OF THE INVENTION

1. Field of the Invention

The present invention relates to a guest management system and more particularly to a hotel booking management system.

2. Description of the Related Art

High working pressure drives people to pursue for better life quality, and traveling to a distant destination has been a much preferred way of relaxation during leisure time. Such outdoor activities mostly include accommodation in hotel.

For hotel accommodation, quests need to show their presence at the front desk of a hotel to complete the check-in procedure so that the hotel can ascertain if any guest expected to check in has not arrived and make a call to confirm. After the hotel confirms that there is any vacant room, this room is available for others without reservation to book.

The normal check-in procedure of a regular hotel is to ask a guest arriving at the hotel to fill out personal information at the front desk and present personal identification, such as driver license or passport, if necessary. The front desk clerk then inputs the personal information of the guest to a computer, and gives a room key to the guest in completion of the check-in procedure after verifying all required information correctly.

However, such regular check-in procedure is usually lengthy and is repetitive if guests need to stay at the same hotel each time. From the perspective of guests, it is really a waste of time, and from the perspective of hotels, such routine procedure also lowers the quality in customer service and becomes a burden in hotel management.

### SUMMARY OF THE INVENTION

An objective of the present invention is to provide a hotel booking management system allowing a guest to fill out personal information thereof beforehand and allowing a hotel to rapidly retrieve the personal information upon arrival of the guest so as to effectively shorten the time for checking in the hotel.

To achieve the foregoing objective, the hotel booking management system has a member services platform, a hotel information services platform, a guest operation interface and a hotel management interface.

The member services platform has a membership registration module serving to register a user as a member and providing a dedicated two-dimensional (2D) barcode to the member after the registration.

The hotel information services platform is linked to the member services platform and has an on-line booking module, an information-providing module and a multimedia services module.

The on-line booking module serves for the member to perform on-line booking of hotel accommodation.

The information-providing module serves to provide travel related information to the member.

The multimedia services module provides multiple types of multimedia entertainment services to a guest in a booked hotel room.

The guest operation interface is linked to the member services platform and is generated on a mobile device of the user connected to the member services platform for registration. After the user is registered as a member, the mobile device receives and displays the 2D barcode.

The hotel management interface is linked to the hotel information services platform and is generated in a management computer to receive and process a service request issued from the member to the hotel information services platform. The management computer is further connected with a barcode reader to scan the 2D barcode and read information associated with the registration and the on-line booking of the member.

Based on the hotel booking management system, a guest's mobile device can connect to the member services platform through the guest operation interface to register for membership. After the registration is completed, the membership registration module of the member services platform stores the guest information and generates a corresponding 2D barcode to the mobile device. When the member books hotel accommodation through the hotel operation interface, the hotel management interface acquires the booking information of the member from the on-line booking module. As long as the 2D barcode in the mobile device is scanned by the hotel upon arrival at the hotel, the booking information can be immediately retrieved to rapidly complete the check-in procedure, thereby raising service quality and operation efficiency of the hotel clerks at the check-in counter.

The hotel management interface is available to each hotel to install so as to establish the hotel information services platform. After finishing a registration, the guest can enter the hotel information services platform to conveniently book hotel accommodation in advance through the on-line booking module.

After a guest is lodged in a hotel, the hotel authorizes corresponding service privileges to the guest so that the guest in the room can enjoy various multimedia entertainment services flexibly played through the mobile device of the guest, instead of being limited to the AV equipment in the room.

Additionally, the information-providing module further provides travel related information, such as timetables of local public transports, flight information update, weather forecast, currency exchange rate and the like for users to easily access all sorts of useful travel related information.

Other objectives, advantages and novel features of the invention will become more apparent from the following detailed description when taken in conjunction with the accompanying drawings.

### BRIEF DESCRIPTION OF THE DRAWINGS

FIG. 1 is a system architecture diagram of a hotel booking management system in accordance with the present invention;

FIG. 2 is a system architecture diagram of a hotel information services platform in the hotel booking management system in FIG. 1;

FIG. 3 is a schematic view of a two-dimensional barcode generated by a member services platform of the hotel booking management system in FIG. 1;

FIGS. 4A-4D are operational schematic views illustrating booking procedures of an on-line booking module of the hotel booking management system in FIG. 1;

FIGS. 5A-5B are operational schematic views of an information-providing module of the hotel booking management system in FIG. 1;

FIG. 6 is an operational schematic view of a multimedia services module of the hotel booking management system in FIG. 1;

FIG. 7 is a schematic view of a guest operation interface of the hotel booking management system in FIG. 1;

FIG. 8 is an operational schematic view of a hotel management interface of the hotel booking management system in FIG. 1;

FIG. 9 is another operational schematic view of the hotel management interface in FIG. 8;

FIG. 10 is an operational schematic view of a message-leaving interface of the hotel booking management system in FIG. 1;

FIG. 11 is another operational schematic view of the information-providing module in FIGS. 5A-5B;

FIGS. 12A-12B are operational schematic views of a hotel information module of the hotel booking management system in FIG. 1; and

FIG. 13 is a schematic view of a maintenance module of the hotel booking management system in FIG. 1.

### DETAILED DESCRIPTION OF THE INVENTION

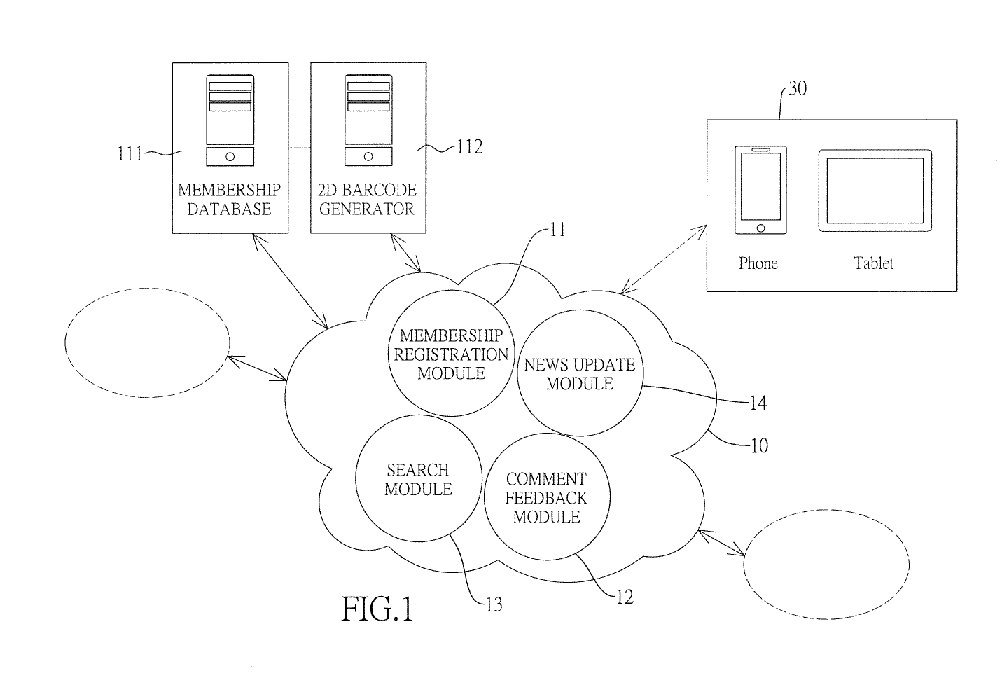

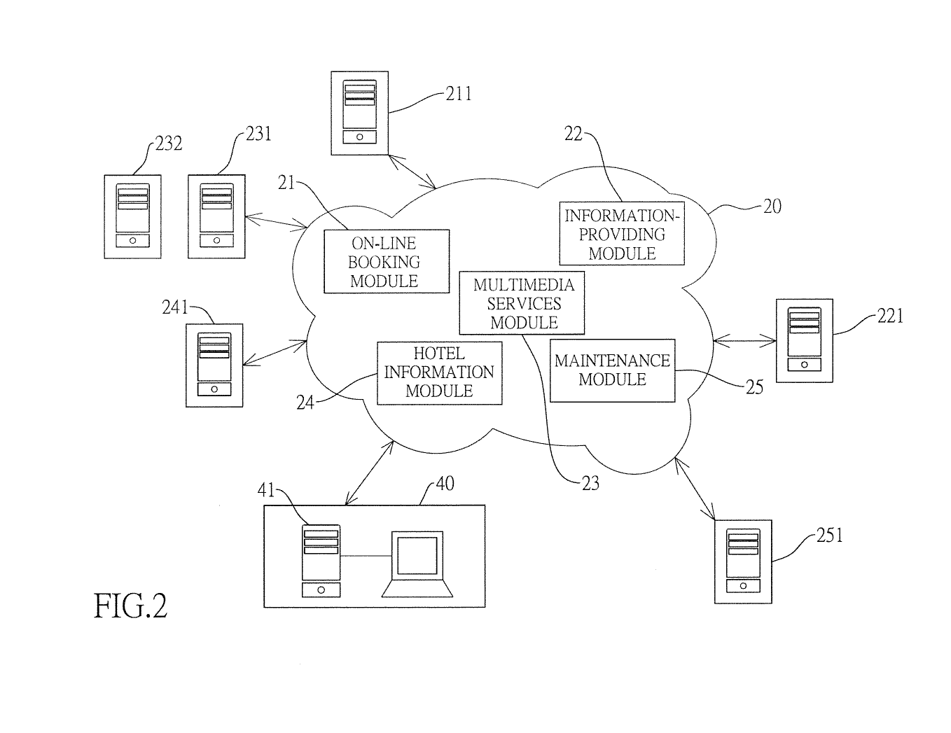

With reference to FIGS. 1 and 2, a hotel booking management system in accordance with the present invention has a member services platform 10, a hotel information services platform 20, a guest operation interface 30 and a hotel management interface 40.

The guest operation interface 30 and the hotel management interface 40 are respectively linked to the member services platform 10 and the hotel information services platform 20.

The member services platform 10 has a membership registration module 11, a comment feedback module 12, a search module 13 and news update module 14.

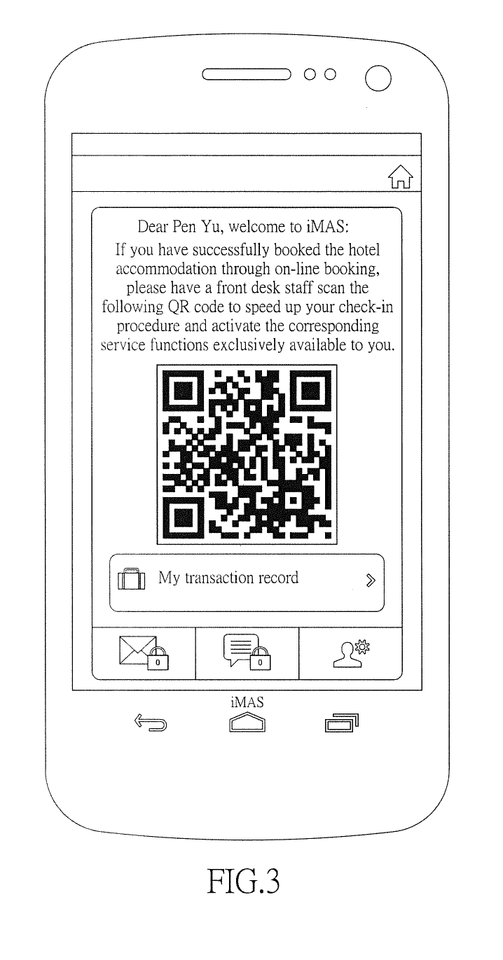

The membership registration module 11 serves to register a user as a member. With reference to FIG. 3, the membership registration module 11 provides a dedicated two-dimensional (2D) barcode to each member after the registration. In the present embodiment, the membership registration module 11 is linked to a membership database 111. The membership database 111 is linked to a 2D barcode generator 112 and stores basic information and the 2D barcode that is generated through the 2D barcode generator 112 of each member.

The comment feedback module 12 serves for each member to input a comment letter and transmits the comment letter to a corresponding hotel.

The search module 13 serves for each user to search for hotels in the nearby or specific hotels so as to search hotel information of those hotels or local travel information.

The news update module 14 lists latest news or promotion information of each hotel to attract users for hotel accommodation.

The hotel information services platform 20 has an on-line booking module 21, an information-providing module 22 and a multimedia services module 23.

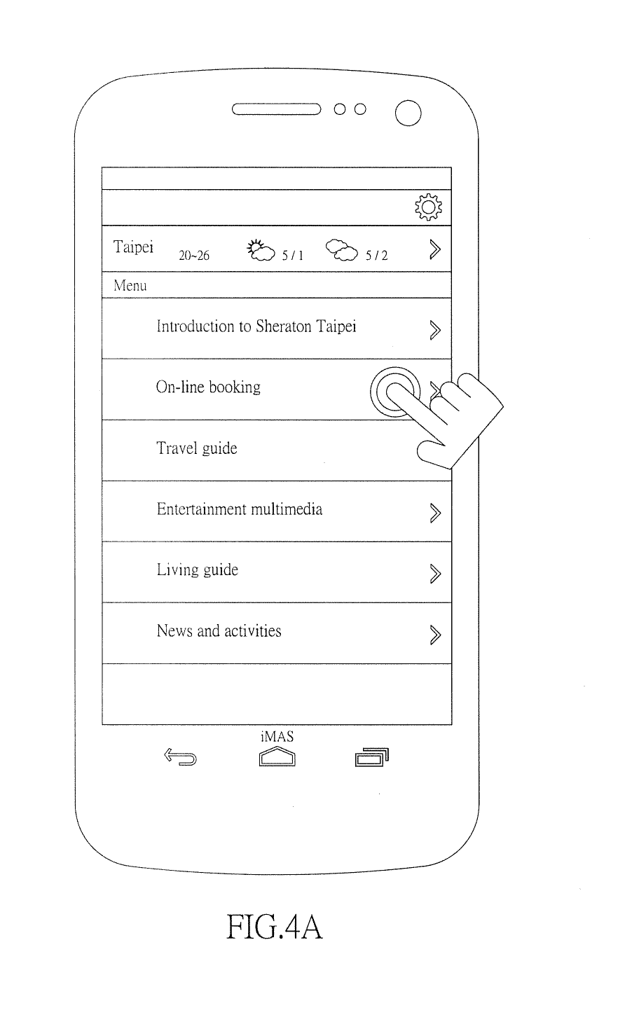

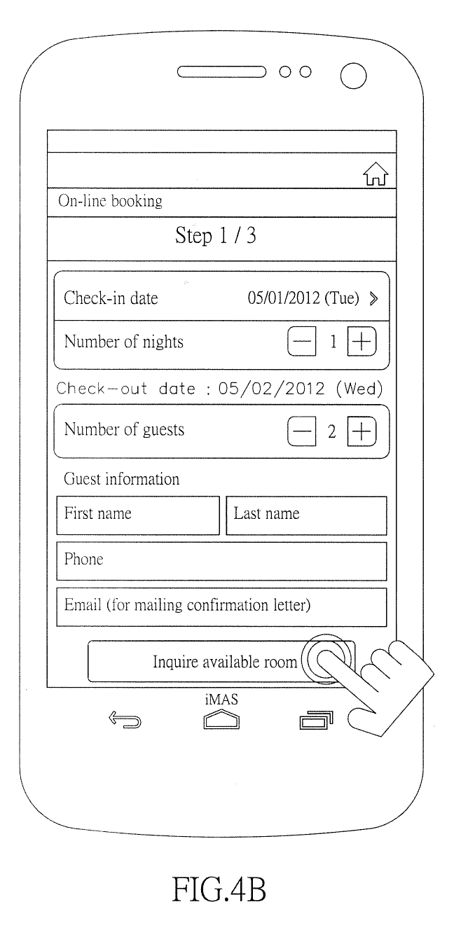

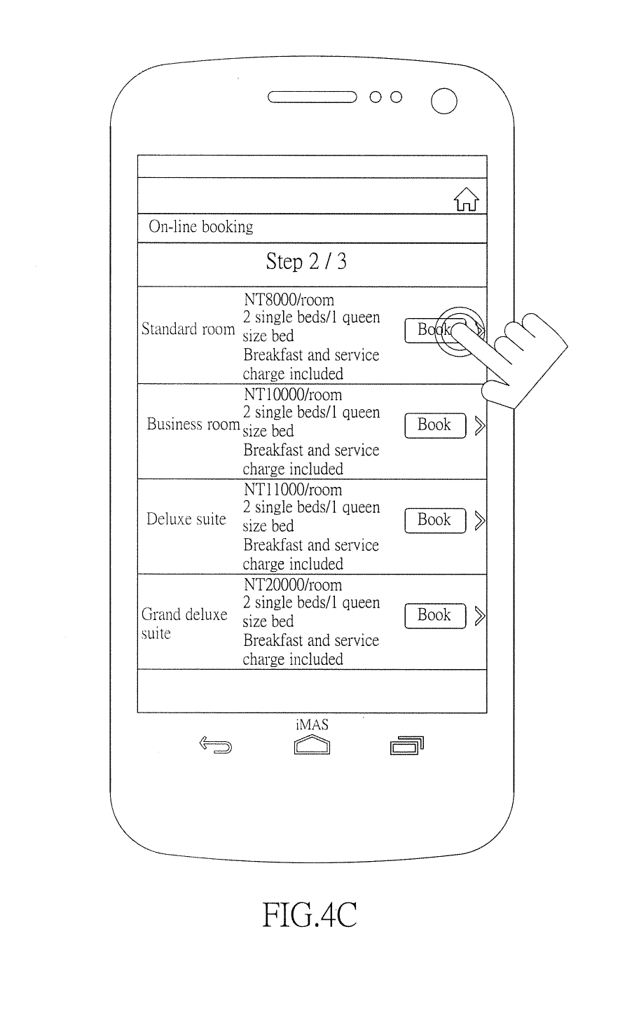

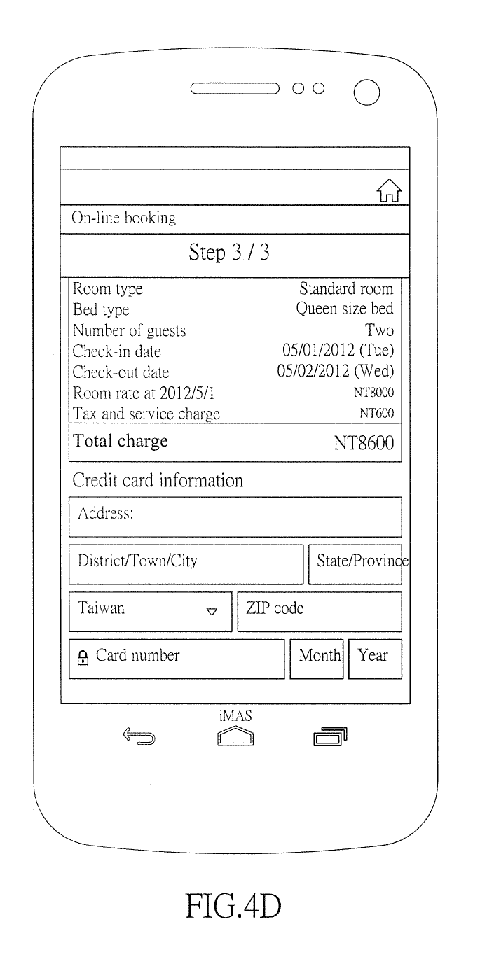

The on-line booking module 21 serves for the members to perform on-line booking of hotel accommodation, and is linked to a booking database 211. With reference to FIGS. 4A-4B, After clicking the on-line booking module 21, a member fills in check-in date, number of nights, number of guests and the like, and then selects a preferred type of room after confirmation. A room rate and payment types are displayed for the member to select in completion of the on-line booking procedures. Hence, it is convenient for members to book hotel accommodation at any time. The on-line booking module 21 is linked to the membership database 111 and stores the basic information and the reservation information of the member in the booking database 211.

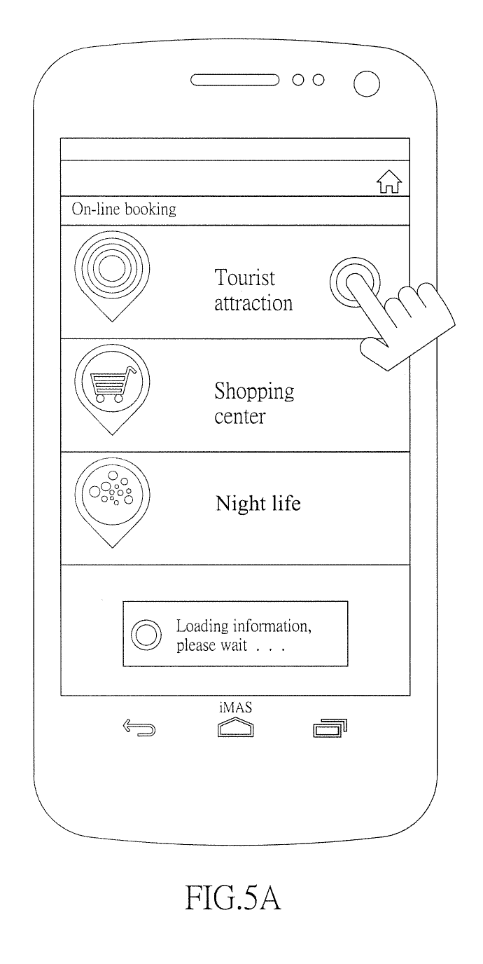

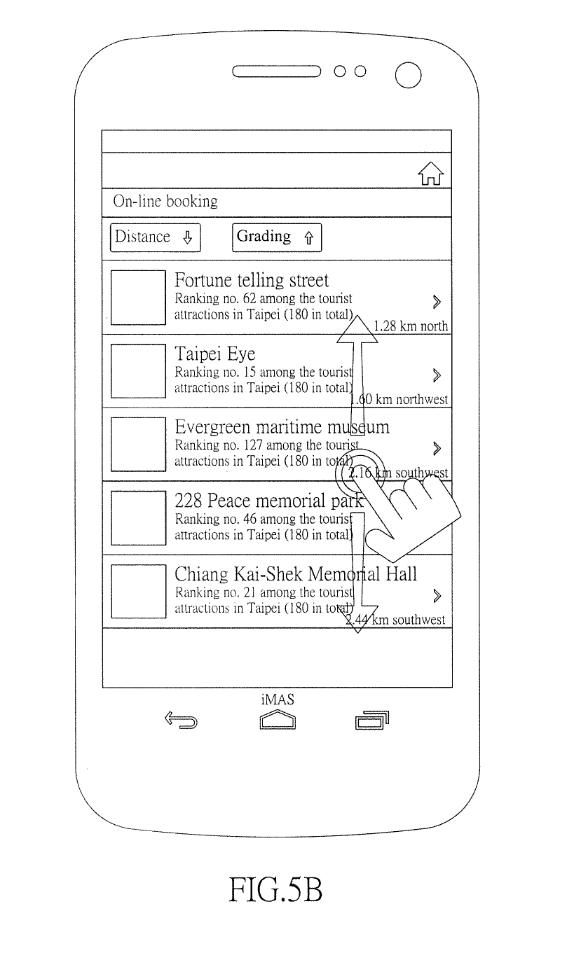

The information-providing module 22 serves to provide users with travel related information of local countries, such as tourist attractions, shopping centers, night life activities and the like. With reference to FIGS. 5A-5B, if users click the option of tourist attractions, the scenic spots and historic spots in the proximity of the hotel or the local area are displayed for users to browse or visit in person. As for the options of shopping centers, night life activities or the like, the operations are similar and are not repeated. In the present embodiment, the information-providing module 22 is linked to a travel information database 221 and stores travel related information pertinent to tourist attractions, shopping centers, night life activities and the like.

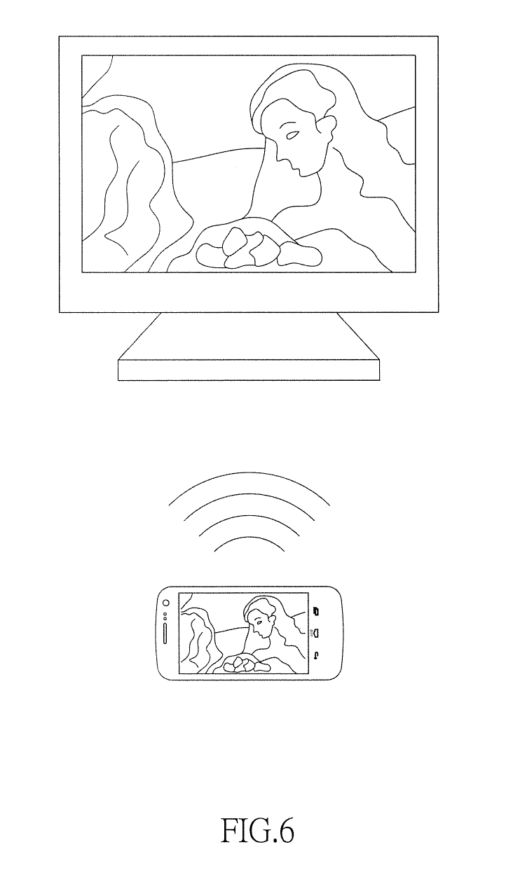

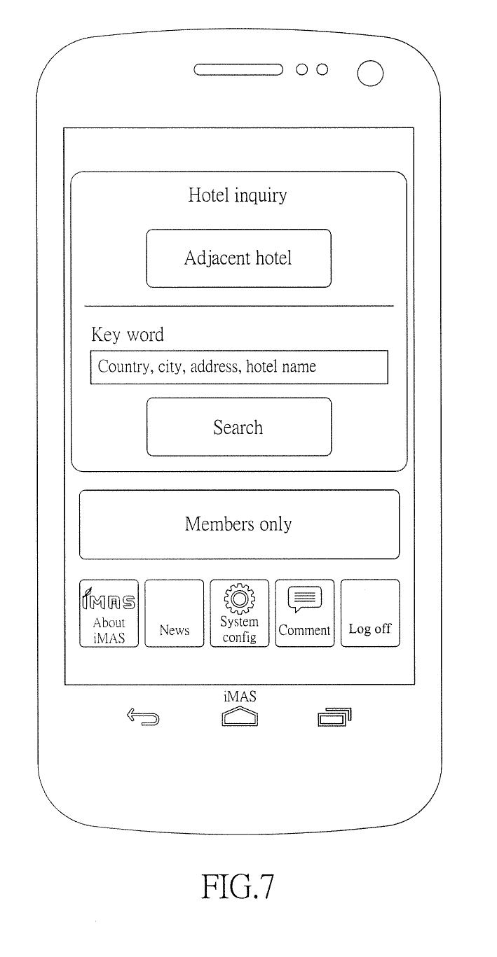

The multimedia services module 23 provides guests with various types of multimedia entertainment services. In the present embodiment, the multimedia services module 23 is linked to a multimedia database 231 and an on-line audio and video (AV) collector 232. The multimedia database 231 stores multiple pieces of AV information, such as movies, TV drama operas and the like, for guests to watch. The on-line AV collector 232 is linked to a regular cable TV or satellite TV receiving module for guests to watch regular cable TV programs or satellite TV programs. With reference to FIG. 6, guests can watch the AV programs on a mobile device thereof or on a stationary indoor AV equipment, such as a TV, through a wired means (HDMI) or a wireless means (WiFi or DLNA) to enjoy the multimedia entertainment services with more flexibility. In the present embodiment, the guest operation interface 30 is generated on a mobile device for users to connect to the member services platform 10. Given the foregoing functions, each member acquires a personal 2D barcode from the membership registration module 11 after being registered as a member. With reference to FIG. 7, the guest operation interface 30 has a configuration interface and a log-off interface. The configuration interface serves for users to set up the language used in the guest operation interface 30 and in the local area. The log-off interface serves for users to log off the guest operation interface 30 so as to prevent unauthorized operation when unattended.

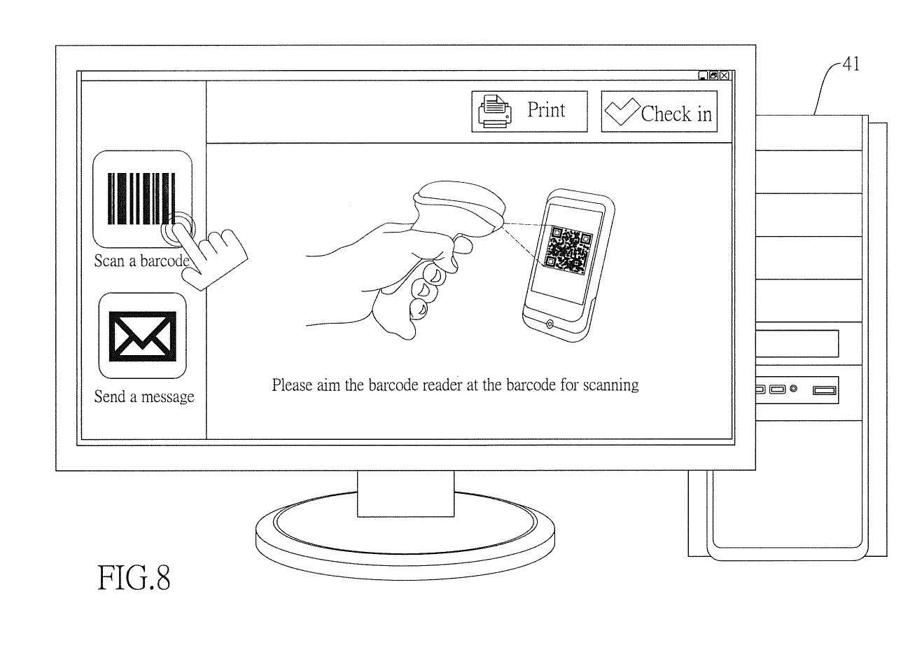

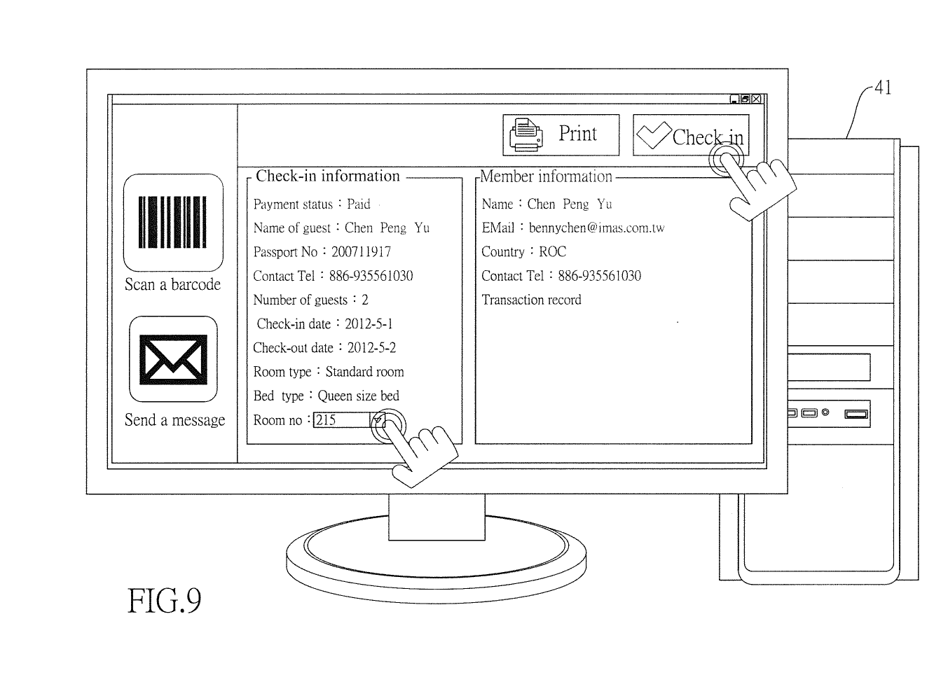

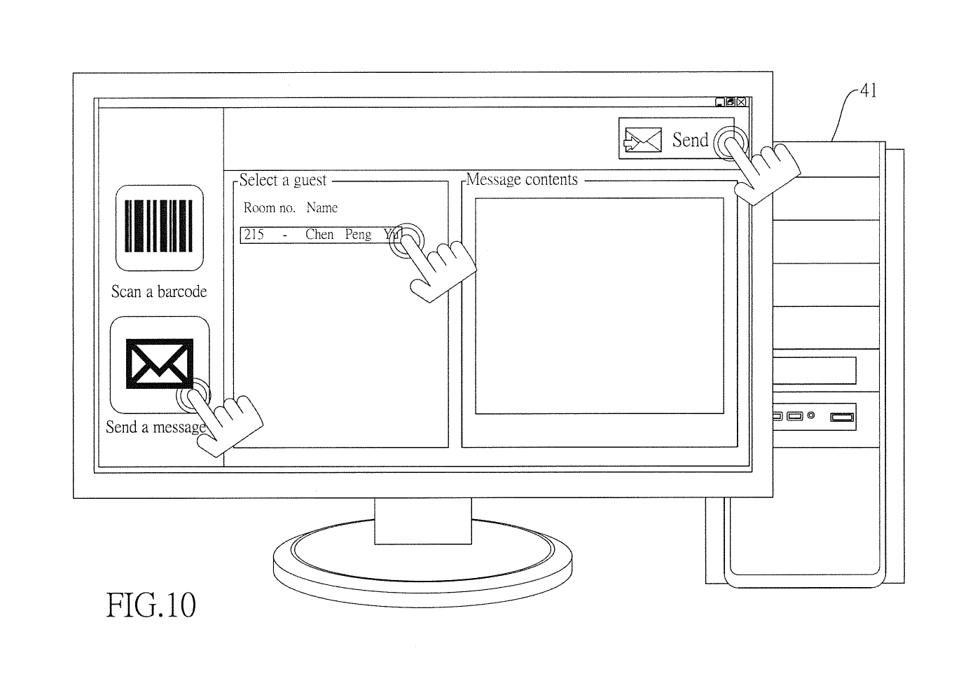

The hotel management interface 40 is linked to the hotel information services platform 20 and is generated in a management computer 41 as shown in FIG. 8 to receive and process service requests issued from the members to the hotel information services platform 20. With reference to FIG. 9, the management computer 41 is further connected with a barcode reader to scan the foregoing 2D barcode, thereby reading the basic information and corresponding booking information of the guests. Furthermore, the hotel management interface 40 has a message-leaving interface. With reference to FIG. 10, the message-leaving interface serves for the hotel clerk to enter a message to a guest in a message-leaving column, such as “you have a visitor in the lobby.” and the like, and sends the message to a mobile device of the guest, so as to instantly inform the guest of the message even if the guest is not around.

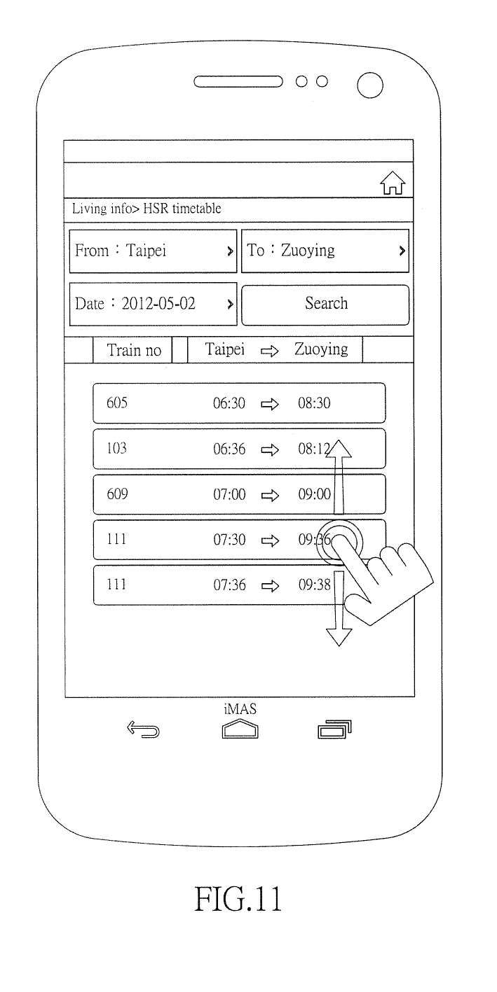

The information-providing module 22 of the hotel information services platform 20 further provides local travel related information, such as timetables of local public transports (railway and bus), flight information update, weather forecast, currency exchange rate, and the like. With reference to FIG. 11, for example, after a user picks a boarding date, train numbers and timetables of Taiwan High Speed Railway (HSR) are shown on the user's mobile device. When a member selects a hotel in Hong Kong, the information-providing module 22 will provide information pertinent to Hong Kong Subway to the member. Other information, such as flight information update, weather forecast or currency exchange rate, are also operated in a similar fashion and is not repeated. Given the information-providing module 22, various useful local travel related information can be accessed by users.

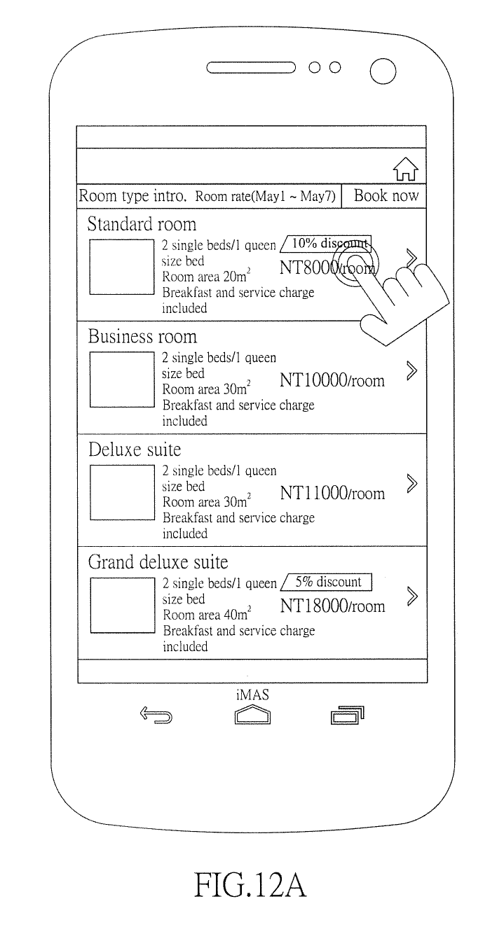

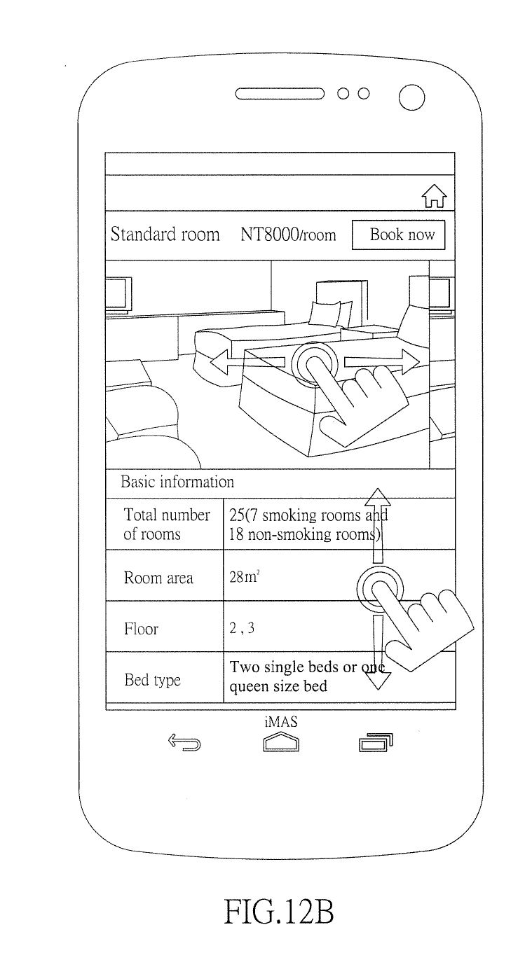

The hotel information services platform 20 further has a hotel information module 24 for introduction of hotel information, such as all facilities in hotels, surrounding environment, room types and promotion information, to attract tourists for hotel accommodation. The hotel information is stored in a hotel information database 241 connected with the hotel information services platform 20 for members to use or for hotel managing personnel to update the information after logging in the hotel information services platform 20. With reference to FIGS. 12A-12B, taking the room type for example, users can click on options for introducing the room type after logging in the hotel information services platform 20, and each type of room and pricing information thereof is thus displayed. According to individual preference, users can select one type of rooms (e.g. deluxe suite) and the pictures, available room(s), size, floor and bed types (e.g. two full sized beds or one queen sized bed) of the type of rooms are shown on mobile devices of users. The operation of all other information options is similar and is not repeated.

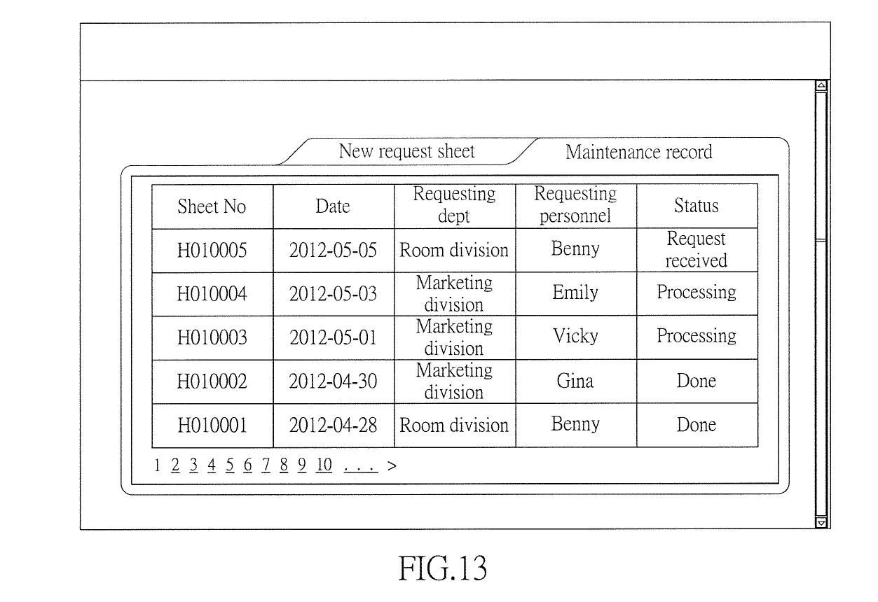

The hotel information services platform 20 further has a maintenance module 25 connected to a maintenance server 251. The maintenance module 25 serves only for a hotel maintenance staff to log in and operate therein. Basically, the maintenance module 25 serves for the hotel maintenance staff to enter the items in the hotel to be repaired and store the items in the maintenance server 251 so as to further phone service personnel for immediate services. Thus, with reference to FIG. 13, management levels of hotels can be aware of damage situations and service conditions of all facilities in hotels to easily proceed with further follow-ups.

Based on the foregoing hotel booking management system, a guest can link to the member services platform 10 through the guest operation interface 30 on a mobile device thereof and is registered as a member. After the membership registration, the membership registration module 11 of the member services platform 10 stores the personal information of the guest and generates a corresponding 2D barcode and forwards the 2D barcode to the mobile device of the guest. When a member completes on-line booking for hotel accommodation through the guest operation interface 30, the hotel management interface 40 obtains the booking information of the member through the on-line booking module 21. When the member is checking in a hotel, the booking information of the member can be retrieved right away once the 2D barcode on the mobile device is scanned by the hotel staff to rapidly complete the check-in procedure, thereby enhancing the service quality and operation efficiency of the front desk. When the member stays in the room, the hotel authorizes corresponding service privileges to the guest so that the guest in the room can enjoy various multimedia entertainment services transmitted from the multimedia database 231 and played by the mobile device of the guest without being limited to the AV equipment in the room. The message-leaving interface of the hotel management interface 40 leaves the messages dedicated to the guest to provide more considerate services. The thoughtful interaction attributable to the foregoing functions of the hotel booking management system between hotels and guests raises service quality and the quest return ratio of hotels.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A hotel booking management system comprising:
a member services platform having a membership registration module serving to register a user as a member and providing a dedicated two-dimensional (2D) barcode to the member after the registration;
a hotel information services platform linked to the member services platform and having:
an on-line booking module serving for the member to perform on-line booking of hotel accommodation;
an information-providing module serving to provide travel related information to the member; and
a multimedia services module providing multiple types of multimedia entertainment services to a guest in a booked hotel room;
a guest operation interface linked to the member services platform and generated on a mobile device of the user connected to the member services platform for registration, wherein after the user is registered as a member, the mobile device receives and displays the 2D barcode; and
a hotel management interface linked to the hotel information services platform and generated in a management computer to receive and process a service request issued from the member to the hotel information services platform, wherein the management computer is further connected with a barcode reader to scan the 2D barcode and read information associated with the registration and the on-line booking of the member.

2. The hotel booking management system as claimed in claim 1, wherein the hotel management interface has a message-leaving interface serving to enter a message and send the message to the mobile device.

3. The hotel booking management system as claimed in claim 2, wherein the multimedia services module is linked to a multimedia database storing multiple pieces of audio and video (AV) information and an on-line AV collector for the guest to selectively watch the AV information through AV equipment in the booked room or the mobile device, and the on-line AV collector is linked to a regular cable TV or satellite TV receiving module.

4. The hotel booking management system as claimed in claim 3, wherein the membership registration module is linked to a membership database, and the membership database is linked to a 2D barcode generator.

5. The hotel booking management system as claimed in claim 4, wherein the information-providing module is linked to a travel information database and stores travel related information pertinent to tourist attractions, shopping centers and night life activities.

6. The hotel booking management system as claimed in claim 5, wherein the information-providing module provides timetables of local public transports, flight information update, weather forecast and currency exchange rate.

7. The hotel booking management system as claimed in claim 6, wherein the hotel information services platform further has a hotel information module connected to a hotel information database storing hotel information about all facilities in hotel, surrounding environment, room types and promotion information.

8. The hotel booking management system as claimed in claim 7, wherein the guest operation interface has:
a configuration interface serving to set up a language used in the guest operation interface and in a local area; and
a log-off interface serving for the user to log off the guest operation interface.

9. The hotel booking management system as claimed in claim 1, wherein the hotel information services platform further has a maintenance module connected to a maintenance server, and the maintenance module serves for a hotel maintenance staff to log in and enter an item in the hotel to be repaired and stores the item in the maintenance server.

10. The hotel booking management system as claimed in claim 2, wherein the hotel information services platform further has a maintenance module connected to a maintenance server, and the maintenance module serves for a hotel maintenance staff to log in and enter an item in the hotel to be repaired and stores the item in the maintenance server.

11. The hotel booking management system as claimed in claim 3, wherein the hotel information services platform further has a maintenance module connected to a maintenance server, and the maintenance module serves for a hotel maintenance staff to log in and enter an item in the hotel to be repaired and stores the item in the maintenance server.

12. The hotel booking management system as claimed in claim 4, wherein the hotel information services platform further has a maintenance module connected to a maintenance server, and the maintenance module serves for a hotel maintenance staff to log in and enter an item in the hotel to be repaired and stores the item in the maintenance server.

13. The hotel booking management system as claimed in claim 5, wherein the hotel information services platform further has a maintenance module connected to a maintenance server, and the maintenance module serves for a hotel maintenance staff to log in and enter an item in the hotel to be repaired and stores the item in the maintenance server.

14. The hotel booking management system as claimed in claim 6, wherein the hotel information services platform further has a maintenance module connected to a maintenance server, and the maintenance module serves for a hotel maintenance staff to log in and enter an item in the hotel to be repaired and stores the item in the maintenance server.

15. The hotel booking management system as claimed in claim 7, wherein the hotel information services platform further has a maintenance module connected to a maintenance server, and the maintenance module serves for a hotel maintenance staff to log in and enter an item in the hotel to be repaired and stores the item in the maintenance server.

16. The hotel booking management system as claimed in claim 8, wherein the hotel information services platform further has a maintenance module connected to a maintenance server, and the maintenance module serves for a hotel maintenance staff to log in and enter an item in the hotel to be repaired and stores the item in the maintenance server.
